(19) United States
(12) Patent Application Publication
(10) Pub. No.: US 2022/0197266 A1
(43) Pub. Date: Jun. 23, 2022

(54) SYSTEM, METHOD, AND RECORDING MEDIUM HAVING PROGRAM RECORDED THEREON

(71) Applicant: Yokogawa Electric Corporation, Tokyo (JP)

(72) Inventors: Takashi NAITO, Tokyo (JP); Paul KENNEDY, Tokyo (JP)

(21) Appl. No.: 17/692,110

(22) Filed: Mar. 10, 2022

Related U.S. Application Data
(63) Continuation of application No. PCT/JP2020/035877, filed on Sep. 23, 2020.

(30) Foreign Application Priority Data
Sep. 30, 2019 (JP) 2019-178746

(51) Int. Cl. G05B 19/418

(52) U.S. Cl. CPC G05B 19/41885; G05B 2219/23123; G05B 19/41875; G05B 19/41865

(57) ABSTRACT

It is rare for the operation of the production site to proceed according to the initially formulated plan, and many deviations occur between the actual operation and the plan. Accordingly, the performance of the production site is preferably analyzed while considering these deviations. Provided is a system including a planning section that generates a production plan for controlling a production site during a target interval, using a planning model; a retrospective planning section that generates a retrospective plan, which is a production plan that retrospectively reflects at least one of unplanned events that occurred after generation of the production plan, using the planning model; and an analyzing section that analyzes production performance of the production site during the target interval, based on the production plan and the retrospective plan.

The contents of the following Japanese patent application(s) are incorporated herein by reference: NO. 2019-178746 filed in JP on Sep. 30, 2019

NO. PCT/JP2020/035877 filed in WO on Sep. 23, 2020

### TECHNICAL FIELD

The present invention relates to a system, a method, and a recording medium having a program recorded thereon.

### RELATED ART

Petroleum refinement is known for refining crude oil to produce multiple petroleum products, as shown in Non-Patent Document 1, for example Conventionally, when operating a relatively large-scale production site, such as a refinery where such petroleum refinement is performed, enterprise resource planning, manufacturing execution, process control, and the like are each performed independently using a system in which different groups (or departments) in an origination are independent from each other.

### PRIOR ART DOCUMENT

### Non-Patent Document

Non-Patent Document 1: Yokomizo, “Petroleum Refining Technology and Petroleum Supply and Demand Trends—Current Status and Future Prospects—,” Japan Petroleum Institute for Natural Gas and Metals; Petroleum, Natural Gas Resources Information, Sep. 20, 2017, Oil and Gas Review Vol. 51 No. 5, p. 1-20.

It is rare for the operation of the production site to proceed according to the initially formulated plan, and many deviations occur between the actual operation and the plan. Accordingly, the performance of the production site is preferably analyzed while considering these deviations.

### GENERAL DISCLOSURE

To solve the above problems, according to a first aspect of the present invention, provided is a system. The system may comprise a planning section that generates a production plan for controlling a production site during a target interval, using a planning model. The system may comprise a retrospective planning section that generates a retrospective plan, which is a production plan that retrospectively reflects at least one of unplanned events that occurred after generation of the production plan, using the planning model. The system may comprise an analyzing section that analyzes production performance of the production site during the target interval, based on the production plan and the retrospective plan.

The retrospective planning section may generate the retrospective plan by changing one or more factors to be input to the planning model in a manner to reflect at least one of the unplanned events.

The retrospective planning section may generate the retrospective plan by changing one or more factors corresponding to each of uncontrollable events that could not be accounted for at the time when the production plan was generated, from a value thereof at the time when the production plan was generated.

The retrospective planning section may generate a plurality of cases of the retrospective plan, where each case is generated by sequentially changing one event at a time among the uncontrollable events, and changing the one or more factors corresponding to the one event from the values thereof at the time when the production plan was generated, and the analyzing section may analyze the production performance for each event, based on the production plan and the plurality of cases of the retrospective plan.

The retrospective planning section may generate the retrospective plan without changing factors other than the one or more factors corresponding to each of the uncontrollable events, from the values thereof at the time when the production plan was generated.

The analyzing section may analyze the production performance further based on actual operation at the production site.

The analyzing section may analyze a deviation of the production performance, caused by the occurrence of at least one of the unplanned events, based on the production plan and the retrospective plan.

The retrospective planning section may generate, as the retrospective plan, an optimal production plan that can be obtained when the occurrence of at least one of the unplanned events is retrospectively reflected.

The system may further comprise a control section that controls the production site based on the production plan.

The planning model may be a linear programming model.

According to a second aspect of the present invention, provided is a method. The method may comprise generating a production plan for controlling a production site during a target interval, using a planning model. The method may comprise generating a retrospective plan, which is a production plan that retrospectively reflects at least one of unplanned events that occurred after generation of the production plan, using the planning model. The method may comprise analyzing production performance of the production site during the target interval, based on the production plan and the retrospective plan.

According to a third aspect of the present invention, provided is a recording medium having a program recorded thereon. The program may be executed by a computer. The program may cause the computer to function as a planning section that generates a production plan for controlling a production site during a target interval, using a planning model. The program may cause the computer to function as a retrospective planning section that generates a retrospective plan, which is a production plan that retrospectively reflects at least one of unplanned events that occurred after generation of the production plan, using the planning model. The program may cause the computer to function as an analyzing section that analyzes production performance of the production site during the target interval, based on the production plan and the retrospective plan.

The summary clause does not necessarily describe all necessary features of the embodiments of the present invention. The present invention may also be a sub-combination of the features described above.

### BRIEF DESCRIPTION OF DRAWINGS

FIG. 1 shows an example of a total solution model 100 of an operation management system that may include the system according to the present embodiment as a portion thereof.

FIG. 2 shows an example of an oil refinement flow at a refinery 120R.

FIG. 3 shows an example of a block diagram of a system 300 according to the present embodiment.

FIG. 4 shows an example of a flow by which the system 300 according to the present embodiment analyzes the production performance of the production site 120.

FIG. 5 shows an example of analysis results of the production performance of the production site 120 obtained by the system 300 according to the present embodiment.

FIG. 6 shows an example of another flow by which the system 300 according to the present embodiment analyzes the production performance of the production site 120.

FIG. 7 shows an example of a computer 2200 in which aspects of the present invention may be wholly or partly embodied.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

A system according to the present embodiment relates to operation of a production site and, as an example, may realize some of the functions of a total solution model that realizes improvement of production efficiency, by organically integrating various functions from an enterprise resource planning (ERP) layer to a manufacturing execution system (MES) layer and a process control system (PCS) layer, and linking management information and control information. As an example, the system according to the present embodiment generates a production plan that retrospectively reflects significant unplanned events that occurred after generation of the production plan, using the planning model that generated the initial production plan, and analyzes the performance of the production site during a target interval, based on the initial production plan and the retrospective production plan, in a portion of such a total solution model.

In the following description, an example is used in which the system according to the present embodiment is applied to the operation performed in a refinery and a petrochemical site, but the present embodiment is not limited to this. As an example, the system according to the present embodiment may be applied to operation at a production site other than a refinery or petrochemical site, for example.

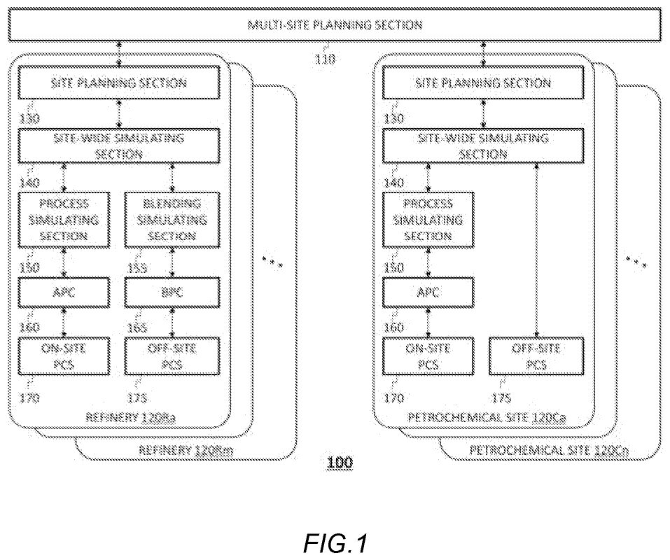

FIG. 1 shows an example of a total solution model 100 of an operation management system that may include the system according to the present embodiment as a portion thereof. The total solution model 100 comprehensively manages a plurality of production sites associated with the same organization (run by the same company, run by the same group of companies, or the like). For example, the total solution model 100 may comprehensively manage a plurality of refineries and a plurality of petrochemical sites that are run worldwide by the same group of companies. In the present drawing, the total solution model 100 includes a multi-site planning section 110, m refineries 120Ra to 120Rm (referred to collectively as the “refineries 120R”), and n petrochemical sites 120Ca to 120Cn (referred to collectively as the “petrochemical sites 120C”). If there is no particular reason to make a distinction, the refineries 120R and the petrochemical sites 120C are referred to collectively as production sites 120.

The multi-site planning section 110 comprehensively generates a production plan for each of the plurality of production sites 120 associated with the same organization. As an example, the multi-site planning section 110 comprehensively generates a production plan for each of the refineries 120Ra to 120Rm and the petrochemical sites 120Ca to 120Cm using a linear programming technique. Generally, with a mathematical model for determining work or intent, the problem of finding the value of a variable that gives the largest objective function under certain mathematical conditions is referred to as a mathematical programming problem. In particular, a case where the expression representing the objective function and the expression representing the mathematical conditions are represented by linear equations of variables is referred to as a linear programming problem. The technique for solving this problem is the linear programming technique.

More specifically, the linear programming technique is generally a technique for solving a problem of maximizing (or minimizing) an objective function shown by Math. 2, under constraint conditions shown by Math. 1. Here, x is an (nxl) variable matrix in which each element is restricted non-negatively by Math. 1. Furthermore, when i=1, 2, or 3, Aᵢ is an (mᵢ×n) coefficient matrix and bᵢ is an (mᵢ×1) coefficient matrix. Furthermore, c is an (n×l) coefficient matrix. In this way, with the linear programming technique, a plurality of linear expressions are used, and each of the plurality of linear expressions is represented as a linear programming table. Each entry in the linear programming table is a coefficient for a respective one of a plurality of variables. The linear programming technique includes deriving a combination of variable values that maximize (or minimize) the objective function of Math. 2, under the constraint conditions shown by Math. 1, by repeatedly testing different combinations of a plurality of variables using matrix mathematics.

$$\begin{matrix}{A}_{1} x \leq {b}_{1} , \\ {A}_{2} x \geq {b}_{2} , \\ {A}_{3} x = {b}_{3} , \\ x \geq 0 & [ Math . 1 ] \\ z = {}^{t} cx & [ Math . 2 ]\end{matrix}$$

As an example, the multi-site planning section 110 acquires business information including crude oil quantity, crude oil type, crude oil price, product price, product demand, process unit availability, process unit maximum capacity, and the like via a network, various memory devices, user input, or the like. A “process unit” refers to a unit that performs any one of various processes needed to produce a product or semi-finished product from a raw material, or any processes associated with these various processes, at the production site 120. The business information such as described above includes a variable (e.g. crude oil price or the like) determined by a business environment or the like and a variable (e.g. crude oil amount or the like) determined by a business decision or the like, for example. It is difficult to purposefully change a variable determined by the business environment or the like, but a variable determined by a business decision or the like can be freely changed to a certain extent at according to the intent of the management. The multi-site planning section 110 derives a combination of variables that maximize the “gross profit”, which is an example of the objective function, by performing a multi-site planning process a plurality of times while changing the values of variables determined by such management decisions or the like. In this case, the multi-site planning section 110 generates, for each of a plurality of production sites 120, a production plan including information such as oil balance (input and output of the production site 120), economic balance (price and income for all input and output of the production site 120), gross profit, operating cost or net profit, energy balance (flow rate and heat quantity of fuel consumed in each process and in all processes in total), a process unit summary (summary of material balance and stream property), a marginal value (value indicating which constraint can realize a greater profit if relaxed), blend summary (summary of a mixture of components including the amount and property of each component), and reports concerning any of the above.

At this time, the multi-site planning section 110 generates, for each production site 120, a production plan for each of one or more relatively long multi-site plan intervals in a relatively long-term multi-site plan period. For example, the multi-site planning section 110 may generate, for each of the plurality of production sites 120, a production plan for each month in a period of the following three months. The multi-site planning section 110 supplies each of the plurality of production sites 120 with the production plans generated respectively for the plurality of production sites 120, via a network, various memory devices, user input, or the like.

The refineries 120R produce a plurality of petroleum products by refining crude oil. The petroleum products of the refineries 120R are described in detail further below. Each refinery 120R includes a site planning section 130, a site-wide simulating section 140, a process simulating section 150, a blending simulating section 155, an APC (Advanced Process Control) 160, a BPC (Blend Property Control) 165, an on-site process control section 170, and an off-site process control section 175. The above describes an example where each refinery 120R is provided with all of these function sections, but the present embodiment is not limited to this. As an example, some of these function sections, e.g. at least one of the site planning section 130, the site-wide simulating section 140, the process simulating section 150, or the blending simulating section 155, may be provided in at a location other than the refinery 120R.

The site planning section 130 generates a production plan for the production site 120 with which it is associated, using the linear programming technique, for example. At this time, the site planning section 130 may use a linear programming table having the same structure as the table used when the multi-site planning section 110 generated the production plan. As an example, the site planning section 130 acquires the production plan for the production site 120 with which the site planning section 130 is associated, from among the production plans generated by the multi-site planning section 110, via a network, various memory devices, user input, or the like. Furthermore, the site planning section 130 acquires business information that is more detailed than the business information used when the multi-site planning section 110 generated the production plan and tailored to the production site 120 with which the site planning section 130 is associated, via a network, various memory devices, user input, or the like. Such detailed business information includes a variable determined by the business environment or the like at site level and a variable determined by a decision or the like made at site level, for example. It is difficult to purposefully change a variable determined by the business environment or the like at site level, but a variable determined by a business decision or the like made at site level can be freely changed to a certain extent at according to the intent at site level. As an example, the site planning section 130 uses a linear programming table with the same structure as the table used by the multi-site planning section 110, to input parameter data that has been determined by the production plan generated by the multi-site planning section 110 and to perform the site planning process a plurality of times while changing the values of the variables determined by a decision or the like made at site level, in order to derive the combination of variable values that maximize the “gross profit”, for example. The site planning section 130 then generates the production plan obtained in this case as the more detailed production plan tailored to the production site 120 with which the site planning section 130 is associated.

At this time, the site planning section 130 generates, for the production site 120 with which the site planning section 130 is associated, a production plan for each of one or more relatively short site planning intervals in a relatively short-term site planning period, compared to the site planning period of the production plan generated by the multi-site planning section 110. For example, the site planning section 130 may generate, for the production site 120 with which the site planning section 130 is associated, a production plan for each week in a period of the following one month. The site planning section 130 supplies the production plan that it generated to another function section or apparatus, via a network, various memory devices, user input, or the like.

If a problem would occur (e.g. if gross profit, production volume requirement, product quality specification, and tank storage capacity would drop below a threshold value or physical constraint) in the production plan of the production site 120 with which the site planning section 130 is associated when using the parameters determined by the production plan generated by the multi-site planning section 110, the site planning section 130 may provide feedback about this problem to the multi-site planning section 110 and generate a request to change a business decision made at the multi-site level.

The site planning section 130 may have a function of a scheduler that schedules operations at the production site 120 in units of single days or multiple days, for example, according to the production plan generated by this site planning section 130. The above describes an example in which the site planning section 130 has the function of a scheduler, but the present embodiment is not limited to this. The refinery 120R may include a scheduler as another function section or apparatus differing from the site planning section 130. The scheduler may acquire basic schedule information including tank information, a transport ship schedule, a pipeline delivery schedule, a road or rail schedule, and the like, for example, via a network, various memory devices, user input, or the like. In a case where the scheduler is configured as a function section or apparatus differing from the site planning section 130, the scheduler acquires the production plan generated by the site planning section 130 via a network, various memory devices, user input, or the like. The scheduler then generates daily schedule information at the production site 120, for example, according to the acquired production plan, and supplies this daily schedule information to another function section or apparatus via a network, various memory devices, user input, or the like.

The site-wide simulating section 140 simulates the site-wide operation of the production site 120. That is, the site-wide simulating section 140 simulates the site-wide behavior of responses corresponding to input, output, and processing content at the production site 120. In the present drawing, the site-wide simulating section 140 performs site-wide simulation of the operation of on-site process units and off-site process units. As an example, “on-site” indicates the site where refining equipment is provided at the refinery 120R. Furthermore, “off-site” indicates a site where equipment around a tank yard that is outside where the refining equipment is provided at the refinery 120R, i.e. a site where ancillary equipment for receiving, storing, blending, and shipping crude oil, products, or semi-finished products is provided. The site-wide simulating section 140 acquires site information including information such as supply flow, product flow, temperature, pressure, and lab data concerning supply quality and product quality at the production site 120, via a network, various memory devices, user input, or the like. As an example, the site-wide simulating section 140 inputs the site information to a steady state model, simulates the operation of the production site 120, and outputs site-wide simulation results including information such as production amount, properties, site conditions, and performance at the production site 120. The steady state model is a model that outputs a constant result that does not change over time, in response to input that does not develop or change over time. At this time, the site-wide simulating section 140 may output the site-wide simulation results based at least partially on the schedule information generated by the scheduler. In other words, the site-wide simulating section 140 may output the site-wide simulation results obtained in a case where the production site 120 operates at least partially according to the schedule generated by the scheduler. Instead, the site-wide simulating section 140 may output the site-wide simulation results obtained in a case where the production site 120 operates according to a schedule that is different from the schedule generated by the scheduler. The site-wide simulating section 140 supplies the output site-wide simulation results to another function section or apparatus via a network, various memory devices, user input, or the like.

The process simulating section 150 simulates the operation of each on-site process unit (group). That is, the process simulating section 150 simulates the behavior of reactions corresponding to input, output, and processing content of each on-site process unit (group). As an example, the process simulating section 150 acquires site information that is more detailed and tailored to each on-site process unit (group) compared to the linear programming in the site planning section 130, via a network, various memory devices, user input, or the like. Then, for example, the process simulating section 150 inputs the more detailed site information into the steady state model, simulates the operation of each on-site process unit (group), and outputs more detailed simulation results for each on-site process unit (group). At this time, the process simulating section 150 may output the simulation results of each on-site process unit (group) based at least partially on the schedule information generated by the scheduler. In other words, the process simulating section 150 may output the simulation results of each on-site process unit (group) obtained in a case where each on-site process unit (group) operates at least partially according to the schedule generated by the scheduler. Instead, the process simulating section 150 may output the simulation results of each on-site process unit (group) obtained in a case where each on-site process unit (group) operates according to a schedule different from the schedule generated by the scheduler. The process simulating section 150 supplies the output simulation results of each on-site process unit (group) to another function section or apparatus via a network, various memory devices, user input, or the like.

The blending simulating section 155 simulates the operation of each process unit (group) that is related to blend property control and located off-site. That is, the blending simulating section 155 simulates the behavior of reactions corresponding to input, output, and processing content each off-site process unit (group) related to blend property control. Blend property control refers to control performed to mix together each component at an off-site location and create products that satisfy certain standards with minimum cost and maximum throughput. The blending simulating section 155 acquires site information that is more detailed and tailored to each off-site process unit (group) related to blend property control, compared to the site information used when the site-wide simulating section 140 output the site-wide simulation results, via a network, various memory devices, user input, or the like. Then, for example, the blending simulating section 155 inputs the more detailed site information into the steady state model, simulates the operation of each off-site process unit (group) related to blend property control, and outputs more detailed simulation results for each off-site process unit (group) related to blend property control. At this time, the blending simulating section 155 may output the simulation results of each off-site process unit (group) related to blend property control based at least partially on the schedule information generated by the scheduler. In other words, the blending simulating section 155 may output the simulation results of each off-site process unit (group) related to blend property control obtained in a case where each off-site process unit (group) related to blend property control operates at least partially according to the schedule generated by the scheduler. Instead, the blending simulating section 155 may output the simulation results of each off-site process unit (group) related to blend property control obtained in a case where each off-site process unit (group) related to blend property control operates according to a schedule different from the schedule generated by the scheduler. The blending simulating section 155 supplies the output simulation results of each off-site process unit (group) related to blend property control to another function section or apparatus via a network, various memory devices, user input, or the like.

The APC 160 is implemented for each process unit (group) that requires advanced control and is located on-site, and performs control at a higher level than the on-site process control section 170 that controls these process units (groups), for example As an example, the APC 160 may set a target value that is a target for controlling the process units (groups), based on at least one of the schedule information generated by the scheduler, a logical unit grouping process simulation of 2-3 units, or the simulation results for each on-site process unit (group) output by the process simulating section 150. The APC 160 then controls the process variation in these process units (groups) by using feedback control or feedforward control in accordance with the target value to perform advanced control of the on-site process control section 170. The APC 160 does not need to be provided for processes that do not justify advanced control.

The BPC 165 is implemented for each process unit (group) that is related to blend property control and located off-site, and performs blend property control for each of these process units (groups) at a higher level than the off-site process control section 175 that controls these process units (groups), for example As an example, the BPC 165 may perform higher level control of the off-site process control section 175 controlling the process units (groups) related to blend property control, based on at least one of the schedule information generated by the scheduler, the site-wide simulation results output by the site-wide simulating section 140, or the simulation results for each process unit (group) related to blend property control output by the blending simulating section 155.

The on-site process control section 170 is implemented for each on-site process unit (group), and is a process control system that automatically manages the operations and processes of these process units (groups), using a computer, for example The process control system referred to here includes a DCS (Distributed Control System), SCADA (Supervisory Control and Data Acquisition), a digital control system, a production information control system, process IT, a technical IT system, or the like. As an example, the on-site process control section 170 may control the on-site process units (groups) based on at least one of the schedule information generated by the scheduler, the site-wide simulation results output by the site-wide simulating section 140, the simulation results of each on-site process unit (group) output by the process simulating section 150, or the control information from the APC 160.

The off-site process control section 175 may be a system similar to the on-site process control section 170, for example. The off-site process control section 175 is implemented for each off-site process unit (group), and is a process control system that automatically manages the operations and processes of these process units (groups), using a computer. As an example, the off-site process control section 175 may control the off-site process units (groups) based on at least one of the schedule information generated by the scheduler, the site-wide simulation results output by the site-wide simulating section 140, the simulation results of each process unit (group) relating to blend property control output by the blending simulating section 155, or the control information from the BPC 165.

The petrochemical sites 120C produce a plurality of chemical products such as synthetic fiber, synthetic resin, and synthetic rubber, by causing a chemical reaction with raw material. The petrochemical sites 120C are similar to the refineries 120R, aside from not including the blending simulating sections 155 and the BPCs 165, and therefore further description is omitted.

In the total solution model 100, there is only one system and only one set of a work process and a model, and all of these are integrated by the flow and transfer of data or information. Accordingly, such a total solution model 100 ensures that the data is accurately and efficiently processed among different groups in an organization. Therefore, as an example, it is possible to realize a large-scale system in which information is linked between a main branch of a company and a refinery, and between multiple refineries, and in which work processes are streamlined and manual work is eliminated.

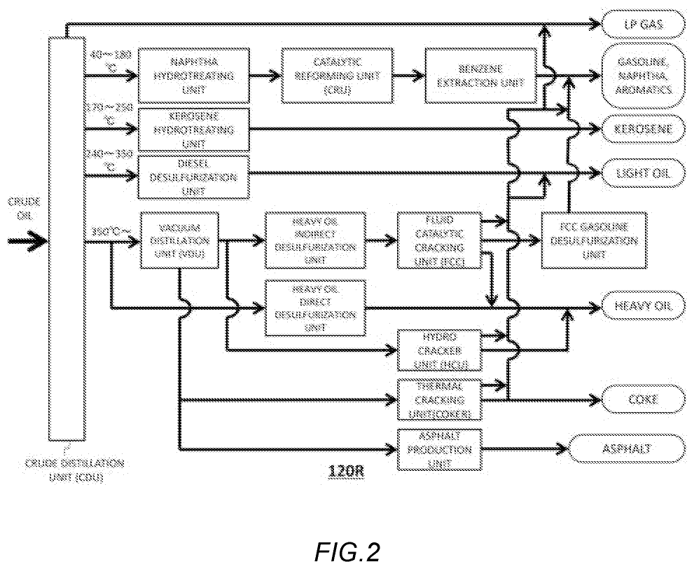

FIG. 2 shows an example of an oil refinement flow at a refinery 120R. At the refinery 120R, crude oil, which is a mixture of hydrocarbons with a wide boiling range, is refined to produce a plurality of petroleum products. Generally, at a refinery 120R, crude oil is distilled in a CDU (Crude Distillation Unit), and separated into fractions with different boiling ranges, i.e. a gas fraction, naphtha fraction, kerosene fraction, light diesel oil fraction, heavy diesel oil fraction and residue fraction, according to a cutoff temperature. LP gas is produced from the gas fraction. The naphtha fraction is hydro-desulfurized by a naphtha hydrotreating unit and then catalytically reformed by a catalytic reforming unit (CRU), and benzene is separated therefrom by a benzene extraction unit to produce gasoline, naphtha, aromatics, and the like. The kerosene fraction is hydro-desulfurized in a kerosene hydrotreating unit to produce kerosene. The light diesel oil fraction is desulfurized in a diesel desulfurization unit to produce light oil. The heavy diesel oil fraction is hydro-desulfurized by a heavy oil direct desulfurization unit to produce heavy oil. Also, the heavy diesel oil fraction is separated into light and heavy fractions in a vacuum distillation unit (VDU). The light fraction separated by VDU is hydro-desulfurized in a heavy oil indirect desulfurization unit, then catalytically cracked in a fluid catalytic cracking (FCC) unit and hydro-desulfurized by an FCC gasoline desulfurization unit, to produce gasoline. Alternatively the light fraction separated by VDU is processed in a hydrocracker unit (HCU). On the other hand, the heavy fraction separated by VDU is pyrolyzed in a thermal cracking unit (Coker) to produce coke, and is also processed in an asphalt production unit to produce asphalt. In the petrochemical industry, naphtha is the main feedstock and olefins e.g. ethylene, propylene and aromatics, e.g. benzene, toluene, aromatic hydrocarbons of xylene (overall so-called BTX) are the main materials obtained.

In the total solution model 100, the on-site process units may include the units described above in the refinery 120R, for example, and the on-site process control section 170 may control the operations and processes of these units. Furthermore, the APC 160 may be implemented for each unit that is particularly important for the operation of the refinery 120R, such as the CDU, VDU, FCC, and CRU, among the units described above, for example.

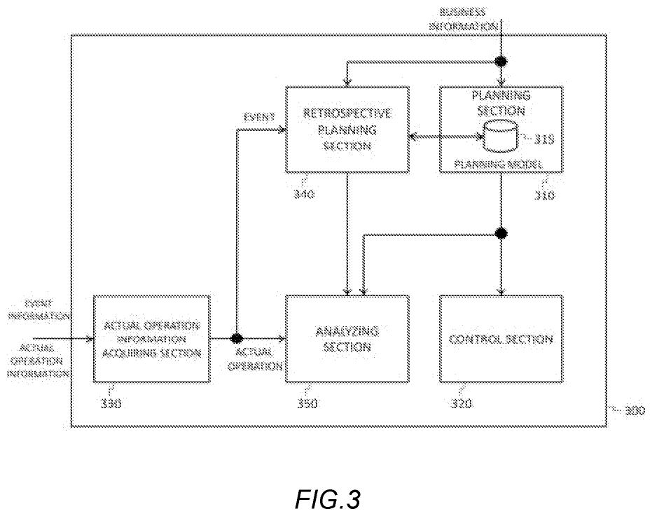

FIG. 3 shows an example of a block diagram of a system 300 according to the present embodiment. The system 300 may realize a portion of the functions of the total solution model 100 shown in FIG. 1, for example. The system 300 according to the present embodiment generates a production plan that retrospectively reflects significant unplanned events that occurred after generation of the production plan, using the planning model that generated the initial production plan, and analyzes the performance of the production site during the target interval, based on the initial production plan and the retrospective production plan.

The system 300 may be a computer such as a PC (personal computer), tablet computer, smartphone, work station, server computer, or general user computer, or may be a computer system in which a plurality of computers are connected. Such a computer system is also a computer, in a broad sense. The system 300 may be implemented in a virtual computer environment that can be executed in one or more computers. Instead, the system 300 may be a specialized computer designed for the purpose of operation of the production site, or may be specialized hardware realized by specialized circuitry. If the system 300 is capable of connecting to the Internet, the system 300 may be realized by cloud computing.

The system 300 according to the present embodiment includes a planning section 310, a control section 320, an actual operation information acquiring section 330, a retrospective planning section 340, and an analyzing section 350. Each block in the present drawing indicates a function block, and does not necessarily correspond to an actual device configuration or apparatus configuration. In other words, in the present drawing, just because function blocks are drawn as separate blocks, this does not limit the configuration to using separate devices or apparatuses for these functions. Furthermore, in the present drawing, just because a function block is shown by a single block, this does not limit the configuration to using a single device or apparatus for this function.

The planning section 310 includes the planning model 315, and generates the production plan for controlling the production site 120 during the target interval using the planning model 315. As an example, the planning section 310 may be the site planning section 130 in the total solution model 100. However, the configuration is not limited to this. As another example, the planning section 310 may be the multi-site planning section 110 in the total solution model 100. The planning section 310 acquires the business information via a network, various memory devices, user input, or the like, and generates the production plan using the acquired business information. The planning section 310 supplies the analyzing section 350 with the generated production plan. Here, the production plan generated by the planning section 310 may be a plan for controlling the production site 120 during the target interval. The planning section 310 supplies the control section 320 with the schedule information in accordance with the generated production plan. The planning section 310 may supply the generated production plan and schedule information to another function section or apparatus, via a network, various memory devices, user input, or the like.

The control section 320 acquires the schedule information from the planning section 310. The control section 320 then controls the production site 120 in accordance with the schedule information obeying the production plan, i.e. based on the production plan.

The actual operation information acquiring section 330 acquires, as the actual results in the target interval, the actual operation information acquired when the production site 120 actually operates according to the control based on the production plan during the target interval, via a network, various memory devices, user input, or the like. The actual operation information acquiring section 330 also acquires information concerning significant unplanned events that affect the operation of the production site 120 during the target interval, which are events that occurred after generation of the production plan. This is described further below. The actual operation information acquiring section 330 supplies the analyzing section 350 with the acquired actual operation information. Furthermore, the actual operation information acquiring section 330 supplies the retrospective planning section 340 with the acquired information relating to the event.

In the same manner as the planning section 310, the retrospective planning section 340 acquires the business information via a network, various memory devices, user input, or the like. Furthermore, the retrospective planning section 340 acquires the information relating to the significant unplanned events that occurred after the generation of the production plan, from the actual operation information acquiring section 330. The retrospective planning section 340 then generates a retrospective plan, which is a production plan that retrospectively reflects at least one of the significant unplanned events that occurred after the generation of the production plan, using the planning model 315. This is described in detail further below. The retrospective planning section 340 supplies the analyzing section 350 with the generated retrospective plan.

The analyzing section 350 acquires the production plan from the planning section 310. Furthermore, the analyzing section 350 acquires the retrospective plan from the retrospective planning section 340. The analyzing section 350 then analyzes the production performance of the production site 120 during the target interval, based on the production plan and the retrospective plan. Furthermore, the analyzing section 350 outputs the analysis result. For example, the analyzing section 350 may display the analysis result on a monitor, write the analysis result into a memory device that can store the data, or supply the analysis result to another function section or apparatus via a network. At this time, the analyzing section 350 may output the analysis result in a data format, a graph format, a table format, or the like.

The following is a detailed description, using a flow, of a case where the production performance of the production site 120 is analyzed by these function sections.

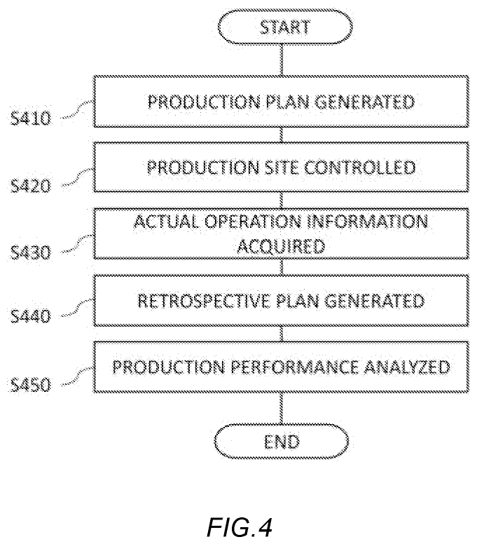

FIG. 4 shows an example of a flow by which the system 300 according to the present embodiment analyzes the production performance of the production site 120.

At step 410, the planning section 310 generates the production plan for controlling the production site 120 during the target interval, using the planning model 315. Here, the planning model 315 may be a linear programming model. In other words, the planning model 315 derives a combination of variable values that maximize (or minimize) the objective function of Math. 2, under the restraint conditions shown by Math. 1, by repeatedly testing different combinations of a plurality of variables using matrix mathematics.

The planning section 310 acquires business information including information such as crude oil quantity, crude oil type, crude oil price, product price, product demand, process unit availability, process unit maximum capacity, or the like via a network, various memory devices, user input, or the like, and inputs this business information to the planning model 315. Next, the planning model 315 derives a combination of variable values that maximize the “gross profit”, using the linear programming technique described above. In this case, the planning section 310 then generates the production plan including information such as oil balance, economic balance, gross profit, operating cost or net profit, energy balance, a process unit summary, a marginal value, a blend summary, and reports concerning any of the above. The planning section 310 then supplies the analyzing section 350 with the generated production plan. Furthermore, the planning section 310 supplies the control section 320 with the schedule information corresponding to the generated production plan.

At step 420, the control section 320 controls the production site 120 in accordance with the schedule information supplied from the planning section 310 at step 410, i.e. based on the production plan.

Here, in the manner described above, the production site 120 may include a refinery 120R that produces a plurality of petroleum products by refining crude oil, for example Accordingly, the control section 320 may set the control target to be a process unit (group) including at least one of a crude distillation unit, vacuum distillation unit, naphtha hydrotreating unit, catalytic reforming unit, benzene extraction unit, kerosene hydrotreating unit, diesel desulfurization unit, heavy oil desulfurization unit (e.g. heavy oil indirect desulfurization unit and/or heavy oil direct desulfurization unit), fluid catalytic cracking unit, FCC gasoline desulfurization unit, thermal cracking unit, hydrocracker unit, or asphalt production unit in the refinery 120R.

The control referred to here is not limited to the control section 320 directly controlling a process unit (group) of the production site 120, and also includes the control section 320 setting a target value that is a target for controlling the processing unit (group) of the production site 120, for example In other words, based on the production plan, the control section 320 directly controls a process unit (group) or sets a target value that is a target for controlling a process unit (group) with the APC 160, the BPC 165, the on-site process control section 170, the off-site process control section 175, or the like that control this process unit (group).

At step 430, the actual operation information acquiring section 330 acquires, as the actual results during the target interval, the actual operation information acquired when the production site 120 operates according to the control based on the production plan during the target interval. The actual operation information acquiring section 330 then supplies the analyzing section 350 with the acquired actual operation information.

Furthermore, the actual operation information acquiring section 330 acquires, via the network, the information concerning significant unplanned events that affect the operation of the production site 120 during the target interval, which are events that occurred after the generation of the production plan.

Here, at step 410, the planning section 310 inputs the business information that was acquired at the timing when the production plan was generated into the planning model 315, to generate the production plan for the target interval that is further in the future than this timing. However, in actuality, after the generation of the production plan by the planning section 310, various unplanned events occur that affect the operation of the production site 120 during the target interval. Examples of such events include crude oil price and product price crashes, unplanned shutdowns of process units, decreases in the capabilities of process units due to bad weather, delays in the arrival of crude oil due to bad weather, divergence of the crude oil from expected properties, unplanned lifting and inventory, or the like, for example Such events are uncontrollable events that could not be accounted for by the organization running the production site 120 at the time when the production plan was generated.

Accordingly, the actual operation information acquiring section 330 acquires information concerning these uncontrollable events that could not be accounted for at the time when the production plan was generated. The actual operation information acquiring section 330 then supplies the retrospective planning section 340 with the acquired information concerning these events.

At step 440, the retrospective planning section 340 acquires the business information via the network. At this time, the retrospective planning section 340 may acquire business information that is the same as the business information acquired by the planning section 310 at step 410. Furthermore, the retrospective planning section 340 acquires the information concerning significant unplanned events that occurred after the generation of the production plan, from the actual operation information acquiring section 330. The retrospective planning section 340 then generates the retrospective plan, which is a production plan that retrospectively reflects at least one of the unplanned events that occurred after the generation of the production plan, using the planning model 315 that is the same as the planning model 315 used when the planning section 310 generated the production plan at step 410.

More specifically, the retrospective planning section 340 generates the retrospective plan by changing one or more factors to be input to the planning model 315 in a manner to reflect at least one of the unplanned events. At this time, the retrospective planning section 340 generates the retrospective plan by changing one or more factors corresponding to each of uncontrollable events that could not be accounted for at the time when the production plan was generated, from a value thereof at the time when the production plan was generated. Furthermore, the retrospective planning section 340 generates the retrospective plan without changing factors other than the one or more factors corresponding to each of these uncontrollable events, from the values thereof at the time when the production plan was generated. In other words, the retrospective planning section 340 changes only the one or more factors corresponding to each of the uncontrollable events that could not be accounted for at the time when the production plan was generated, within the business information input to the planning model 315 by the planning section 310 at step 410, and again inputs these changed factors to the planning model 315. As an example, the retrospective planning section 340 may change all of the factors corresponding to the significant uncontrollable events that could not be accounted for at the time when the production plan was generated in a manner to reflect all of the significant uncontrollable events that occurred, and input these changed factors to the planning model 315.

Then, in the same manner as in step 410, the planning model 315 derives a combination of a plurality of variable values that maximize the “gross profit”, using the linear programming technique described above. The retrospective planning section 340 generates, as the retrospective plan, the optimal (best possible) production plan that can be obtained when the occurrences of at least one of the significant unplanned events that have occurred after the generated of the production plan is retrospectively reflected. The retrospective planning section 340 supplies the analyzing section 350 with the generated retrospective plan.

At step 450, the analyzing section 350 analyzes the production performance of the production site 120 during the target interval, based on the production plan generated at step 410 and the retrospective plan generated at step 440. At this time, the analyzing section 350 may analyze the production performance using only one interval as a target. Instead, the analyzing section 350 may analyze the production performance using an accumulation up to a certain interval as a target. Furthermore, the analyzing section 350 outputs the analysis result. For example, the analyzing section 350 may display the analysis result on a monitor, write the analysis result into a memory device that can store the data, or supply the analysis result to another function section or apparatus via a network. At this time, the analyzing section 350 may output the analysis result in a data format, a graph format, a table format, or the like.

As an example, the analyzing section 350 may analyze the deviation of the production performance, which is caused by the occurrence of at least one of the unplanned events that occurred after the generation of the production plan, based on the production plan and the retrospective plan. For example, the analyzing section 350 may perform a deviation analysis (variation analysis) for the “gross profit” caused by the occurrence of at least some of the events that occurred after the generation of the production plan. Furthermore, at this time, the analyzing section 350 may analyze the production performance of the production site 120 during the target interval further based on the actual operation at the production site 120. This is described in detail in the following drawing.

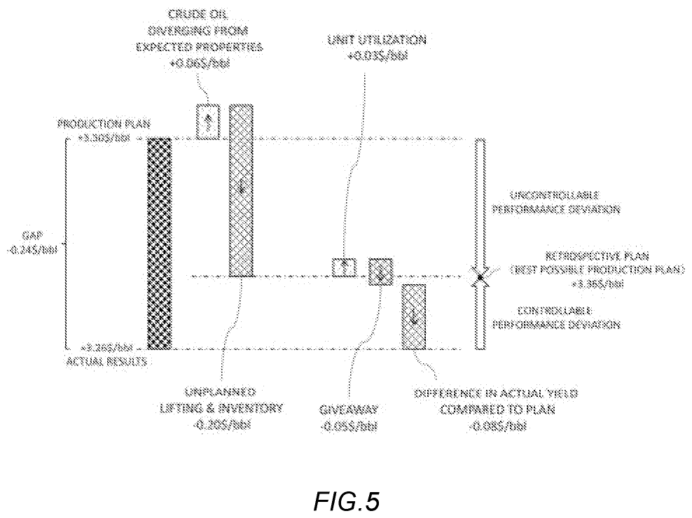

FIG. 5 shows an example of analysis results of the production performance of the production site 120 obtained by the system 300 according to the present embodiment. As shown in the drawing, it is assumed that the planning section 310 has generated a production plan indicating a profit of +3.50$/bbl, i.e. +3.50 dollars per barrel, for example. However, when the production site 120 actually operates according to the control based on this production plan during the target interval, the actual results for the profit obtained by the production site 120 are +3.26$/bbl. In this case, the analyzing section 350 performs an analysis that indicates the occurrence of a profit deviation of −0.24$/bbl between the production plan and the actual results, by subtracting the profit indicated by the actual results from the profit indicated by the production plan, for example.

Furthermore, as an example, it is assumed that the arrival of crude oil diverging from the expected properties at the production site 120 and unplanned lifting and inventory have occurred at the production site 120, as the uncontrollable events that could not be accounted for at the time when the production plan was generated. These uncontrollable events include both events that change the profit to be better than the profit according to the production plan and events that change the profit to be worse than the profit according to the production plan. In this case, the retrospective planning section 340 generates the retrospective plan by changing the plurality of factors corresponding to each of these uncontrollable events, from the values thereof at the time when the production plan was generated. Then, as shown in the present drawing, the retrospective planning section 340 is assumed to generate a retrospective plan indicating a profit of +3.36$/bbl, for example, as the optimal (best possible) production plan that can be adopted when these uncontrollable events are retrospectively reflected. In this way, the analyzing section 350 performs an analysis indicating that a profit deviation of −0.14$/bbl has occurred due to the occurrence of the uncontrollable events, by subtracting the profit indicated by the retrospective plan from the profit indicated by the production plan.

Furthermore, the analyzing section 350 performs an analysis indicating that there is a controllable profit deviation of +0.10$/bbl, by subtracting the profit indicated by the actual results from the profit indicated by the retrospective plan. Here, examples of controllable deviations include a profit deviation caused by a change in unit utilization, a profit deviation caused by giveaways (petroleum products that exceed the required specifications), a deviation in actual process yield relative to the plan, or the like. These deviations are controllable deviations that can be controlled by the organization running the production site 120 when work is performed at the production site 120.

The analysis performed by the analyzing section 350 indicates that, in the profit deviation of −0.24$/bbl that occurred between the production plan and the actual results in this way, an amount of −0.14$/bbl is the profit deviation occurred due to the occurrence of uncontrollable events. In other words, the analysis performed by the analyzing section 350 indicates that the amount of −0.14$/bbl compared to the planned amount is a deviation that could not be avoided no matter how the operation of the production site 120 is optimized, in other words a deviation that the organization running the production site 120 should not be responsible for.

On the other hand, the analysis performed by the analyzing section 350 indicates that, in the profit deviation of −0.24$/bbl that occurred between the production plan and the actual results in this way, an amount of −0.10$/bbl is a controllable deviation. In other words, the analysis performed by the analyzing section 350 indicates that the amount of −0.10$/bbl compared to the planned amount is a deviation that could be improved by optimizing the operation of the production site 120, in other words a deviation that the organization running the production site 120 should be responsible for.

In this way, the analyzing section 350 can identify the degree of each of the profit deviation caused by the occurrence of uncontrollable events that could be not be accounted for by the organization running the production site 120 at the time when the production plan was generated and controllable profit deviation that could have been avoided by the organization running the production site 120 during the time interval of the production plan. Accordingly, the analyzing section 350 can separate the profit deviation caused by the occurrence of uncontrollable events from the profit deviation that occurred between the production plan and the actual results. Similarly, the analyzing section 350 can separate the controllable profit deviation from the profit deviation that occurred between the production plan and the actual results.

In this way, the system 300 can analyze the performance of the production site 120 while taking into consideration the deviation that occurred between the actual operation and the plan. Furthermore, the system 300 according to the present embodiment identifies each of the deviation of the production performance caused by the occurrence of uncontrollable events and the controllable deviation of the production performance, and can therefore clarify the location of the cause of the production performance deviation. In this way, by using the system 300 according to the present embodiment, it is possible to analyze and verify the deviation between the production plan and the actual results in greater detail, in order to remove the causes of this deviation, clarify the management problems and points to be improved, and employ a better business strategy in the future. Furthermore, the system 300 according to the present embodiment is realized as a function of a portion of a total solution model, as described above, and all of the information used by the system 300 is centrally managed and analyzed in the total solution model, and therefore differences in numerical values are less likely to occur between departments. Due to this, the reliability of the data that is the analysis target is increased, and it is possible to correctly perform an effective analysis. The greater the accuracy of the data to be analyzed, the more meaningful the issues and improvements obtained from the analysis results of the system 300 according to the present embodiment.

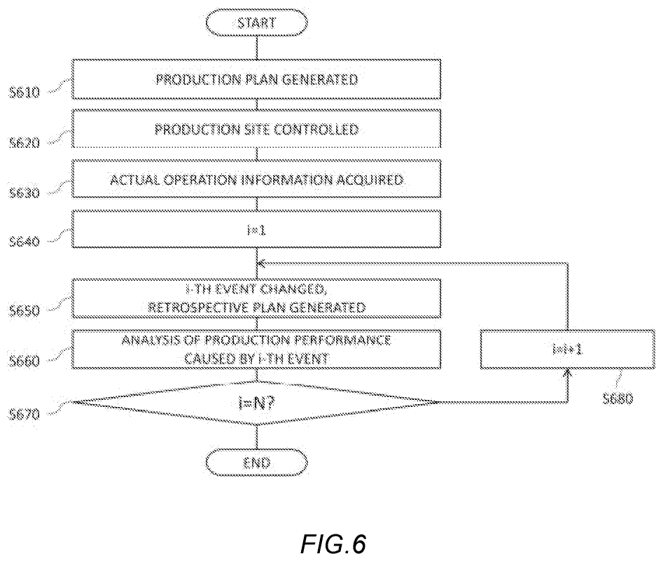

FIG. 6 shows an example of another flow by which the system 300 according to the present embodiment analyzes the production performance of the production site 120. In the above description, an example is shown of a case where the system 300 generates one retrospective plan that reflects all of the uncontrollable events, by changing all of the factors corresponding to the uncontrollable events at once and inputting these factors to the planning model 315. However, in the present flow, the system 300 generates a plurality of cases of the retrospective plan by sequentially changing one event at a time among the uncontrollable events. Steps 610 to 630 in the present drawing are the same as steps 310 to 330 of FIG. 3, and therefore descriptions of these steps are omitted.

At step 640, the system 300 substitutes 1 for i. Here, i is a natural number from 1 to N that indicates ordinal numbers of the uncontrollable events.

At step 650, the retrospective planning section 340 generates a retrospective plan case using the same technique as in step 440, by changing only the i-th event among the uncontrollable events, and changing the one or more factors corresponding to the i-th event from the values thereof at the time when the production plan was generated.

At step 660, the analyzing section 350 analyzes the production performance caused by the changed i-th event, using the same technique as in step 450.

At step 670, the system 300 judges whether i matches N. If it is judged that i matches N, the system 300 ends the process. If it is judged that i does not match N, at step 680, the system 300 increments i, i.e. sets i=i+1, and returns the process to step 650.

After this, the system 300 repeats the process from step 650 to step 680 until it is judged at step 670 that i matches N. In this way, in the present flow, the retrospective planning section 340 generates a plurality of cases of the retrospective plan, where each case is generated by sequentially changing one event (i-th event) at a time among the uncontrollable events, and changing the one or more factors corresponding to the one event from the values thereof at the time when the production plan was generated. Furthermore, the analyzing section 350 analyzes the production performance for each event, based on the production plan and the cases of the retrospective plan. In this way, instead of analyzing the production performance deviations caused by the uncontrollable events all at once which is the final retrospective plan, the system 300 can analyze the production performance for each event among the uncontrollable events, and can analyze and verify the deviation between the plan formulated in advance and the actual results in greater detail.

Various embodiments of the present invention may be described with reference to flowcharts and block diagrams whose blocks may represent (1) steps of processes in which manipulations are performed or (2) sections of apparatuses responsible for performing manipulations. Certain steps and sections may be implemented by dedicated circuitry, programmable circuitry supplied with computer-readable instructions stored on computer-readable media, and/or processors supplied with computer-readable instructions stored on computer-readable media. Dedicated circuitry may include digital and/or analog hardware circuits and may include integrated circuits (IC) and/or discrete circuits. Programmable circuitry may include reconfigurable hardware circuits comprising logical AND, OR, XOR, NAND, NOR, and other logical manipulations, flip-flops, registers, memory elements, etc., such as field-programmable gate arrays (FPGA), programmable logic arrays (PLA), etc.

Computer-readable media may include any tangible device that can store instructions for execution by a suitable device, such that the computer-readable medium having instructions stored therein comprises an article of manufacture including instructions which can be executed to create means for performing manipulations specified in the flowcharts or block diagrams. Examples of computer-readable media may include an electronic storage medium, a magnetic storage medium, an optical storage medium, an electromagnetic storage medium, a semiconductor storage medium, etc. More specific examples of computer-readable media may include a floppy disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY™ disc, a memory stick, an integrated circuit card, etc.

Computer-readable instructions may include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk (registered trademark), JAVA (registered trademark), C++, etc., and conventional procedural programming languages, such as the “C” programming language or similar programming languages.

Computer-readable instructions may be provided to a processor of a general purpose computer, special purpose computer, or other programmable data processing apparatus, or to programmable circuitry, locally or via a local area network (LAN), wide area network (WAN) such as the Internet, etc., to execute the computer-readable instructions to create means for performing manipulations specified in the flowcharts or block diagrams. Examples of processors include computer processors, processing units, microprocessors, digital signal processors, controllers, microcontrollers, etc.

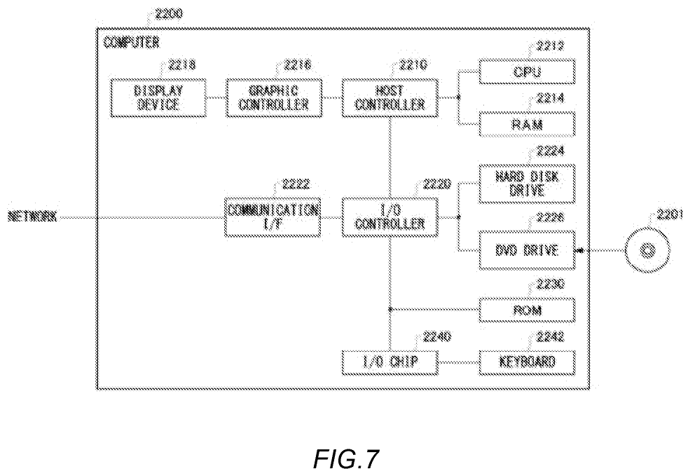

FIG. 7 shows an example of a computer 2200 in which aspects of the present invention may be wholly or partly embodied. A program that is installed in the computer 2200 can cause the computer 2200 to function as or perform manipulations associated with apparatuses of the embodiments of the present invention or one or more sections thereof, and/or cause the computer 2200 to perform processes of the embodiments of the present invention or steps thereof. Such a program may be executed by the CPU 2212 to cause the computer 2200 to perform certain manipulations associated with some or all of the blocks of flowcharts and block diagrams described herein.

The computer 2200 according to the present embodiment includes a CPU 2212, a RAM 2214, a graphics controller 2216, and a display device 2218, which are mutually connected by a host controller 2210. The computer 2200 also includes input/output units such as a communication interface 2222, a hard disk drive 2224, a DVD-ROM drive 2226 and an IC card drive, which are connected to the host controller 2210 via an input/output controller 2220. The computer also includes legacy input/output units such as a ROM 2230 and a keyboard 2242, which are connected to the input/output controller 2220 through an input/output chip 2240.

The CPU 2212 operates according to programs stored in the ROM 2230 and the RAM 2214, thereby controlling each unit. The graphics controller 2216 obtains image data generated by the CPU 2212 on a frame buffer or the like provided in the RAM 2214 or in itself, and causes the image data to be displayed on the display device 2218.

The communication interface 2222 communicates with other electronic devices via a network. The hard disk drive 2224 stores programs and data used by the CPU 2212 within the computer 2200. The DVD-ROM drive 2226 reads the programs or the data from the DVD-ROM 2201, and provides the hard disk drive 2224 with the programs or the data via the RAM 2214. The IC card drive reads programs and data from an IC card, and/or writes programs and data into the IC card.

The ROM 2230 stores therein a boot program or the like executed by the computer 2200 at the time of activation, and/or a program depending on the hardware of the computer 2200. The input/output chip 2240 may also connect various input/output units via a parallel port, a serial port, a keyboard port, a mouse port, or the like to the input/output controller 2220.

A program is provided by computer readable media such as the DVD-ROM 2201 or the IC card. The program is read from the computer readable media, installed into the hard disk drive 2224, RAM 2214, or ROM 2230, which are also examples of computer readable media, and executed by the CPU 2212. The information processing described in these programs is read into the computer 2200, resulting in cooperation between a program and the above-mentioned various types of hardware resources. An apparatus or method may be constituted by realizing the manipulation or processing of information in accordance with the usage of the computer 2200.

For example, when communication is performed between the computer 2200 and an external device, the CPU 2212 may execute a communication program loaded onto the RAM 2214 to instruct communication processing to the communication interface 2222, based on the processing described in the communication program. The communication interface 2222, under control of the CPU 2212, reads transmission data stored on a transmission buffering region provided in a recording medium such as the RAM 2214, the hard disk drive 2224, the DVD-ROM 2201, or the IC card, and transmits the read transmission data to a network or writes reception data received from a network to a reception buffering region or the like provided on the recording medium.

In addition, the CPU 2212 may cause all or a necessary portion of a file or a database to be read into the RAM 2214, the file or the database having been stored in an external recording medium such as the hard disk drive 2224, the DVD-ROM drive 2226 (DVD-ROM 2201), the IC card, etc., The CPU 2212 may then write back the processed data to the external recording medium.

Various types of information, such as various types of programs, data, tables, and databases, may be stored in the recording medium to undergo information processing. The CPU 2212 may perform various types of processing on the data read from the RAM 2214, which includes various types of manipulations, processing of information, condition judging, conditional branch, unconditional branch, search/replace of information, etc., as described throughout this disclosure and designated by an instruction sequence of programs, and writes the result back to the RAM 2214. In addition, the CPU 2212 may search for information in a file, a database, etc., in the recording medium. For example, when a plurality of entries, each having an attribute value of a first attribute associated with an attribute value of a second attribute, are stored in the recording medium, the CPU 2212 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-explained program or software modules may be stored in the computer readable media on or near the computer 2200. In addition, a recording medium such as a hard disk or a RAM provided in a server system connected to a dedicated communication network or the Internet can be used as the computer readable media, thereby providing the program to the computer 2200 via the network.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### LIST OF REFERENCE NUMERALS

100: total solution model; 110: multi-site planning section; 120: production site; 120R: refinery; 120C: petrochemical site; 130: site planning section; 140: site-wide simulating section; 150: process simulating section; 155: blending simulating section; 160: APC; 165: BPC; 170: on-site process control section; 175: off-site process control section; 300: system; 310: planning section; 315: planning model; 320: control section; 330: actual operation information acquiring section; 340: retrospective planning section; 350: analyzing section; 2200: computer; 2201: DVD-ROM; 2210: host controller; 2212: CPU; 2214: RAM; 2216: graphic controller; 2218: display device; 2220: input/output controller; 2222: communication interface; 2224: hard disk drive; 2226: DVD-ROM drive; 2230: ROM; 2240: input/output chip; 2242: keyboard

What is claimed is:

1. A system comprising:
a planning section that generates a production plan for controlling a production site during a target interval, using a planning model;
a retrospective planning section that generates a retrospective plan, which is a production plan that retrospectively reflects at least one of unplanned events that occurred after generation of the production plan, using the planning model; and
an analyzing section that analyzes production performance of the production site during the target interval, based on the production plan and the retrospective plan.

2. The system according to claim 1, wherein
the retrospective planning section generates the retrospective plan by changing one or more factors to be input to the planning model in a manner to reflect at least one of the unplanned events.

3. The system according to claim 2, wherein
the retrospective planning section generates the retrospective plan by changing one or more factors corresponding to each of uncontrollable events that could not be accounted for at the time when the production plan was generated, from a value thereof at the time when the production plan was generated.

4. The system according to claim 3, wherein
the retrospective planning section generates a plurality of cases of the retrospective plan, where each case is generated by sequentially changing one event at a time among the uncontrollable events, and changing the one or more factors corresponding to the one event from the values thereof at the time when the production plan was generated, and
the analyzing section analyzes the production performance for each event, based on the production plan and the plurality of cases of the retrospective plan.

5. The system according to claim 3, wherein
the retrospective planning section generates the retrospective plan without changing factors other than the one or more factors corresponding to each of the uncontrollable events, from the values thereof at the time when the production plan was generated.

6. The system according to claim 4, wherein
the retrospective planning section generates the retrospective plan without changing factors other than the one or more factors corresponding to each of the uncontrollable events, from the values thereof at the time when the production plan was generated.

7. The system according to claim 1, wherein
the analyzing section analyzes the production performance further based on actual operation at the production site.

8. The system according to claim 2, wherein
the analyzing section analyzes the production performance further based on actual operation at the production site.

9. The system according to claim 3, wherein
the analyzing section analyzes the production performance further based on actual operation at the production site.

10. The system according to claim 4, wherein
the analyzing section analyzes the production performance further based on actual operation at the production site.

11. The system according to claim 1, wherein
the analyzing section analyzes a deviation of the production performance, caused by the occurrence of at least one of the unplanned events, based on the production plan and the retrospective plan.

12. The system according to claim 2, wherein
the analyzing section analyzes a deviation of the production performance, caused by the occurrence of at least one of the unplanned events, based on the production plan and the retrospective plan.

13. The system according to claim 1, wherein
the retrospective planning section generates, as the retrospective plan, an optimal production plan that can be obtained when the occurrence of at least one of the unplanned events is retrospectively reflected.

14. The system according to claim 2, wherein
the retrospective planning section generates, as the retrospective plan, an optimal production plan that can be obtained when the occurrence of at least one of the unplanned events is retrospectively reflected.

15. The system according to claim 1, further comprising:
a control section that controls the production site based on the production plan.

16. The system according to claim 2, further comprising:
a control section that controls the production site based on the production plan.

17. The system according to claim 1, wherein
the planning model is a linear programming model.

18. The system according to claim 2, wherein
the planning model is a linear programming model.

19. A method comprising:
generating a production plan for controlling a production site during a target interval, using a planning model;
generating a retrospective plan, which is a production plan that retrospectively reflects at least one of unplanned events that occurred after generation of the production plan, using the planning model; and
analyzing production performance of the production site during the target interval, based on the production plan and the retrospective plan.

20. A recording medium recorded thereon a program that, when executed by a computer, causes the computer to function as:
a planning section that generates a production plan for controlling a production site during a target interval, using a planning model;
a retrospective planning section that generates a retrospective plan, which is a production plan that retrospectively reflects at least one of unplanned events that occurred after generation of the production plan, using the planning model; and
an analyzing section that analyzes production performance of the production site during the target interval, based on the production plan and the retrospective plan.
